(19) United States
(12) Patent Application Publication
(10) Pub. No.: US 2020/0143115 A1
(43) Pub. Date: May 7, 2020

(54) SYSTEMS AND METHODS FOR IMPROVED AUTOMATED CONVERSATIONS

(71) Applicant: Conversica, Inc., Foster City, CA (US)

(72) Inventors: Benjamin P. Brigham, Bellingham, WA (US); Siddhartha Reddy Jonnalagadda, Bothell, WA (US); Kerri Louise Rapes, Sperncerville, IN (US); Cesar Alexis Flores Suazo, Amsterdam (NL)

(21) Appl. No.: 16/723,735

(22) Filed: Dec. 20, 2019

Related U.S. Application Data
(63) Continuation-in-part of application No. 16/019,382, filed on Jun. 26, 2018.
Application No. 16/019,382 is a continuation-in-part of application No. 14/604,610, filed on Jan. 23, 2015, now Pat. No. 10,026,037.
Application No. 14/604,610 is a continuation-in-part of application No. 14/604,602, filed on Jan. 23, 2015.
Application No. 14/604,602 is a continuation-in-part of application No. 14/604,594, filed on Jan. 23, 2015.
(60) Provisional application No. 62/784,696, filed on Dec. 24, 2018.

(51) Int. Cl. G06F 40/30; G06N 20/00; G06N 5/04; G06F 40/295; G06F 40/174

(52) U.S. Cl. CPC G06F 40/30; G06N 20/00; G06F 40/174; G06F 40/295; G06N 5/04

(57) ABSTRACT

Systems and methods for parsing a message in a conversation series is provided. This involves receiving a message, isolating the current exchange, dividing it up into sentences, and detecting the language being used. The message sentences are normalized, and any ‘speech acts’ are identified. Likewise, any ‘critical intents’ are identified. If there is no critical intent, the classification text is provided to sets of models for parallel prediction of the intent(s) of the message. Models are queried for based upon series of the conversation, the industry involved, the client the model is for, the message campaign, and any speech acts present. Mapping rules and/or prediction machine learning models are used to convert the intents into meanings, which are filtered. It is also possible to apply a decision engine policy for the determination of the meaning. This is followed by entity extraction and response generation by mapping meanings to actions.

### CROSS REFERENCE TO RELATED APPLICATIONS

This continuation-in-part application is a non-provisional and claims the benefit of U.S. provisional application of the same title, U.S. provisional application No. 62/784,696, Attorney Docket No. CVSC-18G-P, filed in the USPTO on Dec. 24, 2018.

This continuation-in-part application also claims the benefit of U.S. application entitled “Systems and Methods for Natural Language Processing and Classification,” U.S. application Ser. No. 16/019,382, Attorney Docket No. CVSC-17A1-US, filed in the USPTO on Jun. 26, 2018, pending, which is a continuation-in-part application which claims the benefit of U.S. application entitled “Systems and Methods for Configuring Knowledge Sets and AI Algorithms for Automated Message Exchanges,” U.S. application Ser. No. 14/604,610, Attorney Docket No. CVSC-1403, filed in the USPTO on Jan. 23, 2015, now U.S. Pat. No. 10,026,037 issued Jul. 17, 2018. Additionally, U.S. application Ser. No. 16/019,382 claims the benefit of U.S. application entitled “Systems and Methods for Processing Message Exchanges Using Artificial Intelligence,” U.S. application Ser. No. 14/604,602, Attorney Docket No. CVSC-1402, filed in the USPTO on Jan. 23, 2015, pending, and U.S. application entitled “Systems and Methods for Management of Automated Dynamic Messaging,” U.S. application Ser. No. 14/604,594, Attorney Docket No. CVSC-1401, filed in the USPTO on Jan. 23, 2015, pending.

All of the above-referenced applications/patents are incorporated herein in their entirety by this reference.

### BACKGROUND

The present invention relates to systems and methods for natural language processing and generation of more “human” sounding artificially generated conversations. Such natural language processing techniques may be employed in the context of machine learned conversation systems. These conversational AIs include, but are not limited to, message response generation, AI assistant performance, and other language processing, primarily in the context of the generation and management of a dynamic conversations. Such systems and methods provide a wide range of business people more efficient tools for outreach, knowledge delivery, automated task completion, and also improve computer functioning as it relates to processing documents for meaning. In turn, such system and methods enable more productive business conversations and other activities with a majority of tasks performed previously by human workers delegated to artificial intelligence assistants.

Artificial Intelligence (AI) is becoming ubiquitous across many technology platforms. AI enables enhanced productivity and enhanced functionality through “smarter” tools. Examples of AI tools include stock managers, chatbots, and voice activated search-based assistants such as Siri and Alexa. With the proliferation of these AI systems, however, come challenges for user engagement, quality assurance and oversight.

When it comes to user engagement, many people do not feel comfortable communicating with a machine outside of certain discrete situations. A computer system intended to converse with a human is typically considered limiting and frustrating. This has manifested in a deep anger many feel when dealing with automated phone systems, or spammed, non-personal emails.

These attitudes persist even when the computer system being conversed with is remarkably capable. For example, many personal assistants such as Siri and Alexa include very powerful natural language processing capabilities; however, the frustration when dealing with such systems, especially when they do not “get it” persists. Ideally an automated conversational system provides more organic sounding messages in order to reduce this natural frustration on behalf of the user. Indeed, in the perfect scenario, the user interfacing with the AI conversation system would be unaware that they are speaking with a machine rather than another human.

In order for a machine to sound more human or organic includes improvements in natural language processing and the generation of accurate, specific and contextual action to meaning rules.

It is therefore apparent that an urgent need exists for advancements in the natural language processing techniques used by AI conversation systems, including contextual analysis by leveraging speech acts, and through the advanced construction of a rule data base populated by sophisticated recommendations. Such systems and methods allow for improved conversations and for added functionalities.

### SUMMARY

To achieve the foregoing and in accordance with the present invention, systems and methods for improved natural language processing are provided. Such systems and methods allow for more effective AI operations, improvements to the experience of a conversation target, and increased productivity through AI assistance.

In some embodiments, systems and methods are provided for parsing a message in a conversation series. This involves receiving a message, which is a collection of a series of exchanges including earlier exchanges and a current exchange. The different exchanges are identified in the message, and the earlier ones are removed to isolate the current exchange. The current exchange is then divided up into sentences, and the language being used is detected. Language detection may include running different language models on the message, and selecting the language for the model with the highest confidence.

Next, the message sentences are normalized. This may include converting to lowercase strings, identifying specific parts of speech and replacing it with tokens, generating n-grams, and the like. The normalization results in a classification text being outputted. Additionally, it may be desirable to analyze the normalized message text for what is known as a “speech act”, which basically categorizes the sentences into a type of speaking action: a question, statement, command, desire or commitment. A feature set for the sentence is defined responsive to the identified speech act, and a hierarchy of meanings is generated responsive to the defined features.

At this stage a “critical intent” is looked for within the message. Such a critical intent may be readily identified by a rule based analysis and can indicate that a particular meaning exists within the message, thereby eliminating the need for more complicated prediction activities.

However, if there is no critical intent present, the classification text is provided to sets of models for parallel prediction of the intent(s) of the message. Each model is predicts the intent with a given confidence level. Models are queried for based upon series of the conversation, the industry involved, the client the model is for, and the message campaign to select which of the machine learning models to use for intent determination. If a speech act was identified previously, the models used to analyze the statement may differ based upon which speech type exists. For example, some models may be well tuned for analyzing statements, but fail to have accurate results for questions.

Mapping rules and/or prediction machine learning models are used to convert the intents into meanings. These meanings may be filtered (e.g., by a threshold cutoff of some other filtering methodology) to arrive at the final meaning of the exchange. It is also possible to apply a decision engine policy for the determination of the meaning. The decision engine policy removes at least one of the plurality of machine learning models and replaces a probability of the predicted meaning for the removed models to 1.

It may also be desirable to perform an entity extraction step after classification (or immediately after the critical intent is identified). Entity extraction removes the names of people and entities, dates, and abstractions (such as a phone number) and replaces it with tokens denoting the kind of data that was extracted. Entity extraction can include identifying system level entities, AI level entities and custom level entities, and organizing an entity hierarchy.

Lastly, a reply may be generated based upon this meaning and a given business objective, the target involved, and industry segment. The final predicted meanings can be mapped to at least one action, which determines the reply message. A set of message templates may be employed for this message generation process.

In some embodiments, systems and methods for recommending statements, questions and commands and associated intents to a conversation builder are provided. This system includes a statement/question/command topic modeler that receives a response, determines how many responses are directed to a given statement, question or command, and then modeling a topic for the response. Next the system can try to associate an intent with the topic. If this association is not possible, then a master statement, question or command is proposed to a master statement/question/command creator. This creator identifies intents, and associates current intents to the topic, and confirms the meaning rules with a user.

On an interface the user can provide an industry selection. Then a list of historical statements, questions and commands responsive to the selected industry are presented back to the user. The user provides a selection of one of these statements/questions/commands, and also selects an intent from the presented list that have historically associated with this selected statements/questions/command. This generates a new intent rule. An intent creator, likewise, generates a meaning combination rule. In a relational database the selected intent is mapped to a meaning according to the new intent rules, and the selected intent is linked to an action according to the meaning combination rules.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generation and implementation of messaging conversations, in accordance with some embodiment;

FIG. 2 is an example logical diagram of a dynamic messaging server, in accordance with some embodiment;

FIG. 3 is an example logical diagram of a user interface within the dynamic messaging server, in accordance with some embodiment;

FIG. 4 is an example logical diagram of a message generator within the dynamic messaging server, in accordance with some embodiment;

FIG. 5A is an example logical diagram of a message response system within the dynamic messaging server, in accordance with some embodiment;

FIG. 5B is an example logical diagram of a recommendation engine, in accordance with some embodiment;

FIG. 5C is an example logical diagram of a message receiver, in accordance with some embodiment;

FIG. 5D is an example logical diagram of a data processor, in accordance with some embodiment;

FIG. 5E is an example logical diagram of a message delivery handler, in accordance with some embodiment;

FIG. 6 is an example flow diagram for a dynamic message conversation, in accordance with some embodiment;

FIG. 7 is an example flow diagram for the process of on-boarding a business actor, in accordance with some embodiment;

FIG. 8 is an example flow diagram for the process of building a business activity such as conversation, in accordance with some embodiment;

FIG. 9 is an example flow diagram for the process of generating message templates, in accordance with some embodiment;

FIG. 10 is an example flow diagram for the process of implementing the conversation, in accordance with some embodiment;

FIG. 11 is an example flow diagram for the process of preparing and sending the outgoing message, in accordance with some embodiment;

FIG. 12 is an example flow diagram for the process of processing received responses, in accordance with some embodiment;

FIG. 13 is an example flow diagram for the process of document cleaning, in accordance with some embodiment;

FIG. 14 is an example flow diagram for message classification, in accordance with some embodiment;

FIG. 15 is an example flow diagram for speech act identification, in accordance with some embodiment;

FIG. 16 is an example flow diagram for entity recognition, in accordance with some embodiment;

FIG. 17 is an example flow diagram for action setting responsive to message meaning, in accordance with some embodiment;

FIG. 18 is an example flow diagram for the process for recommendation of statements, questions and commands and associated intents in a conversation builder responsive to historical data, in accordance with some embodiment;

FIG. 19A-19C are example screenshots of meaning model metadata for differing speech acts, in accordance with some embodiment; and

FIGS. 20A and 20B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to enhancements to traditional natural language processing techniques and subsequent actions taken by an automated system. While such systems and methods may be utilized with any AI system, such natural language processing particularly excel in AI systems relating to the generation of automated messaging for business conversations such as marketing and other sales functions. While the following disclosure is applicable for other combinations, we will focus upon natural language processing in AI marketing systems as an example, to demonstrate the context within which the enhanced natural language processing excels.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements in natural language processing and actions taken in response to such message exchanges, within conversation systems, and for employment of domain specific assistant systems that leverage these enhanced natural language processing techniques. The goal of the message conversations is to enable a logical dialog exchange with a recipient, where the recipient is not necessarily aware that they are communicating with an automated machine as opposed to a human user. This may be most efficiently performed via a written dialog, such as email, text messaging, chat, etc. However, given the advancement in audio and video processing, it may be entirely possible to have the dialog include audio or video components as well.

In order to effectuate such an exchange, an AI system is employed within an AI platform within the messaging system to process the responses and generate conclusions regarding the exchange. These conclusions include calculating the context of a document, intents, entities, sentiment and confidence for the conclusions. Human operators, through a “training desk” interface, cooperate with the AI to ensure as seamless an experience as possible, even when the AI system is not confident or unable to properly decipher a message. The natural language techniques disclosed herein assist in making the outputs of the AI conversation system more effective, and more ‘human sounding’, which may be preferred by the recipient/target of the conversation.

### I. Dynamic Messaging Systems with Enhanced Natural Language Processing

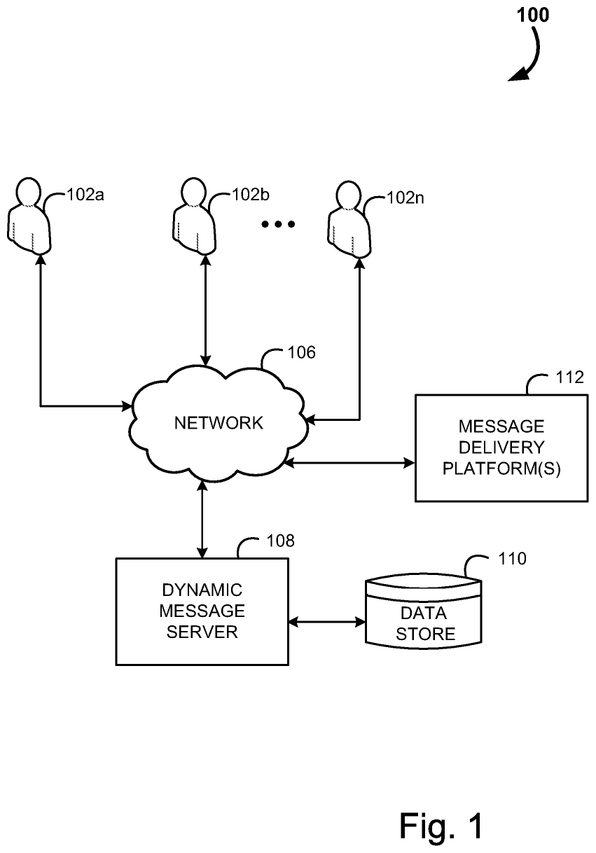

To facilitate the discussion, FIG. 1 is an example logical diagram of a system for generating and implementing messaging conversations, shown generally at 100. In this example block diagram, several users 102a-n are illustrated engaging a dynamic messaging system 108 via a network 106. Note that messaging conversations may be uniquely customized by each user 102a-n in some embodiments. In alternate embodiments, users may be part of collaborative sales departments (or other collaborative group) and may all have common access to the messaging conversations. The users 102a-n may access the network from any number of suitable devices, such as laptop and desktop computers, work stations, mobile devices, media centers, etc.

The network 106 most typically includes the internet but may also include other networks such as a corporate WAN, cellular network, corporate local area network, or combination thereof, for example. The messaging server 108 may distribute the generated messages to the various message delivery platforms 112 for delivery to the individual recipients. The message delivery platforms 112 may include any suitable messaging platform. Much of the present disclosure will focus on email messaging, and in such embodiments the message delivery platforms 112 may include email servers (Gmail, Yahoo, Outlook, etc.). However, it should be realized that the presently disclosed systems for messaging are not necessarily limited to email messaging. Indeed, any messaging type is possible under some embodiments of the present messaging system. Thus, the message delivery platforms 112 could easily include a social network interface, instant messaging system, text messaging (SMS) platforms, or even audio or video telecommunications systems.

One or more data sources 110 may be available to the messaging server 108 to provide user specific information, message template data, knowledge sets, intents, and target information. These data sources may be internal sources for the system's utilization or may include external third-party data sources (such as business information belonging to a customer for whom the conversation is being generated). These information types will be described in greater detail below. This information may be leveraged, in some embodiments, to generate a profile regarding the conversation target. A profile for the target may be particularly useful in a sales setting where differing approaches may yield dramatically divergent outcomes. For example, if it is known that the target is a certain age, with young children, and with an income of $75,000 per year, a conversation assistant for a car dealership will avoid presenting the target with information about luxury sports cars, and instead focus on sedans, SUVs and minivans within a budget the target is likely able to afford. By engaging the target with information relevant to them, and sympathetic to their preferences, the goals of any given conversation are more likely to be met. The external data sources typically relied upon to build out a target profile may include, but are not limited to, credit applications, CRM data sources, public records data sets, loyalty programs, social media analytics, and other “pay to play” data sets, for example.

The other major benefit of a profile for the target is that data that the system “should know” may be incorporated into the conversation to further personalize the message exchange. Information the system “should know” is data that is evident trough the exchange, or the target would expect the AI system would know. Much of the profile data may be public, but a conversation target would feel strange (or even violated) to know that the other party they are communicating with has such a full set of information regarding them. For example, a consumer doesn't typically assume a retailer knows how they voted in the last election, but through an AI conversational system with access to third party data sets, this kind of information may indeed be known. Bringing up such knowledge in a conversation exchange would strike the target as strange, at a minimum, and may actually interfere with achieving the conversation objectives. In contrast, offered information, or information the target assumes the other party has access to, can be incorporated into the conversation in a manner that personalizes the exchange, and makes the conversation more organic sounding. For example if the target mentions having children, and is engaging an AI system deployed for an automotive dealer, a very natural message exchange could include “You mentioned wanting more information on the Highlander SUV. We have a number in stock, and one of our sales reps would love to show you one and go for a test drive. Plus they are great for families. I'm sure your kids would love this car.”

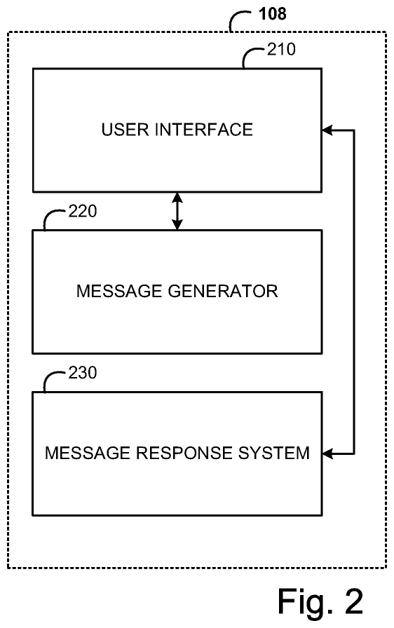

Moving on, FIG. 2 provides a more detailed view of the dynamic messaging server 108, in accordance with some embodiment. The server is comprised of three main logical subsystems: a user interface 210, a message generator 220, and a message response system 230. The user interface 210 may be utilized to access the message generator 220 and the message response system 230 to set up messaging conversations and manage those conversations throughout their life cycle. At a minimum, the user interface 210 includes APIs to allow a user's device to access these subsystems. Alternatively, the user interface 210 may include web accessible messaging creation and management tools.

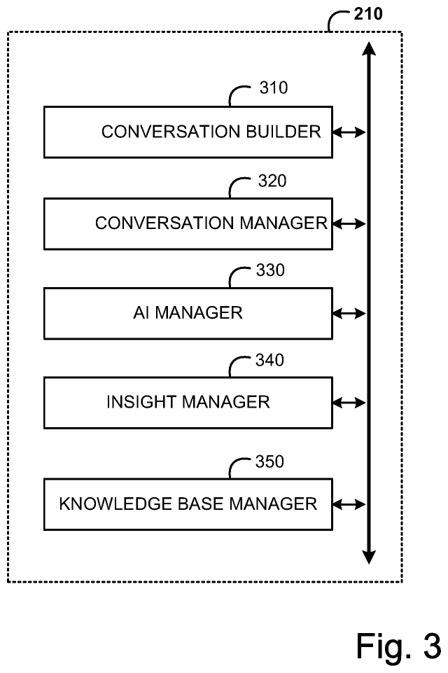

FIG. 3 provides a more detailed illustration of the user interface 210. The user interface 210 includes a series of modules to enable the previously mentioned functions to be carried out in the message generator 220 and the message response system 230. These modules include a conversation builder 310, a conversation manager 320 an AI manager 330, an intent manager 340, and a knowledge base manager 350.

The conversation builder 310 allows the user to define a conversation, and input message templates for each series/exchange within the conversation. A knowledge set and target data may be associated with the conversation to allow the system to automatically effectuate the conversation once built. Target data includes all the information collected on the intended recipients, and the knowledge set includes a database from which the AI can infer context and perform classifications on the responses received from the recipients.

The conversation manager 320 provides activity information, status, and logs of the conversation once it has been implemented. This allows the user 102a to keep track of the conversation's progress, success and allows the user to manually intercede if required. The conversation may likewise be edited or otherwise altered using the conversation manager 320.

The AI manager 330 allows the user to access the training of the artificial intelligence which analyzes responses received from a recipient. One purpose of the given systems and methods is to allow very high throughput of message exchanges with the recipient with relatively minimal user input. To perform this correctly, natural language processing by the AI is required, and the AI (or multiple AI models) must be correctly trained to make the appropriate inferences and classifications of the response message. The user may leverage the AI manager 330 to review documents the AI has processed and has made classifications for.

In some embodiments, the training of the AI system may be enabled by, or supplemented with, conventional CRM data. The existing CRM information that a business has compiled over years of operation is incredibly rich in detail, and specific to the business. As such, by leveraging this existing data set the AI models may be trained in a manner that is incredibly specific and valuable to the business. CRM data may be particularly useful when used to augment traditional training sets, and input from the training desk. Additionally, social media exchanges may likewise be useful as a training source for the AI models. For example, a business often engages directly with customers on social media, leading to conversations back and forth that are again, specific and accurate to the business. As such this data may also be beneficial as a source of training material.

The intent manager 340 allows the user to manage intents. As previously discussed, intents are a collection of categories used to answer some statement, question or command about a document. For example, a statement, question or command for the document could include “is the lead looking to purchase a car in the next month?” Answering this statement, question or command can have direct and significant importance to a car dealership. Certain categories that the AI system generates may be relevant toward the determination of this statement, question or command. These categories are the ‘intent’ to the statement, question or command and may be edited or newly created via the intent manager 340. As will be discussed in greater detail below, the generation of statements, questions and commands and associated intents may be facilitated by leveraging historical data via a recommendation engine.

In a similar manner, the knowledge base manager 350 enables the management of knowledge sets by the user. As discussed, a knowledge set is a set of tokens with their associated category weights used by an aspect (AI algorithm) during classification. For example, a category may include “continue contact?”, and associated knowledge set tokens could include statements such as “stop”, “do no contact”, “please respond” and the like.

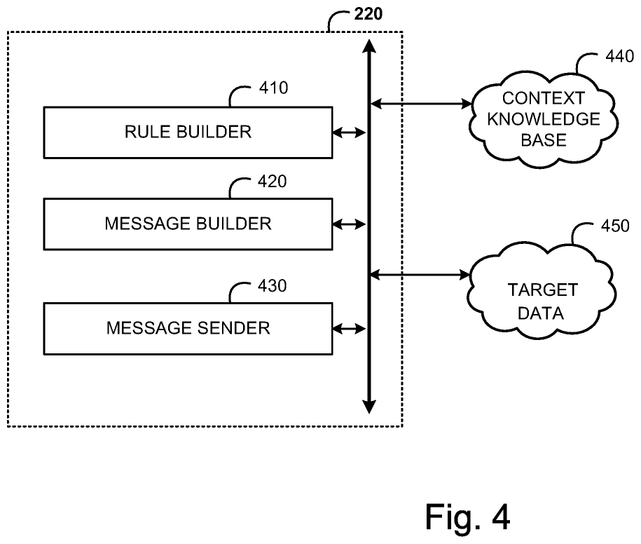

Moving on to FIG. 4, an example logical diagram of the message generator 220 is provided. The message generator 220 utilizes context knowledge 440 and target data 450 to generate the initial message. The message generator 220 includes a rule builder 410 which allows the user to define rules for the messages. A rule creation interface which allows users to define a variable to check in a situation and then alter the data in a specific way. For example, when receiving the scores from the AI, if the intent is Interpretation and the chosen category is ‘good’, then have the Continue Messaging intent return ‘continue’.

The rule builder 410 may provide possible phrases for the message based upon available target data. The message builder 420 incorporates those possible phrases into a message template, where variables are designated, to generate the outgoing message. Multiple selection approaches and algorithms may be used to select specific phrases from a large phrase library of semantically similar phrases for inclusion into the message template. For example, specific phrases may be assigned category rankings related to various dimensions such as “formal vs. informal, education level, friendly tone vs. unfriendly tone, and other dimensions,” Additional category rankings for individual phrases may also be dynamically assigned based upon operational feedback in achieving conversational objectives so that more “successful” phrases may be more likely to be included in a particular message template. Phrase package selection will be discussed in further detail below. The selected phrases incorporated into the template message is provided to the message sender 430 which formats the outgoing message and provides it to the messaging platforms for delivery to the appropriate recipient.

Feedback may be collected from the conversational exchanges, in many embodiments. For example if the goal of a given message exchange is to set up a meeting, and the target agrees to said meeting, this may be counted as successful feedback. However, it may also be desirable to collect feedback from external systems, such as transaction logs in a point of sales system, or through records in a CRM system.

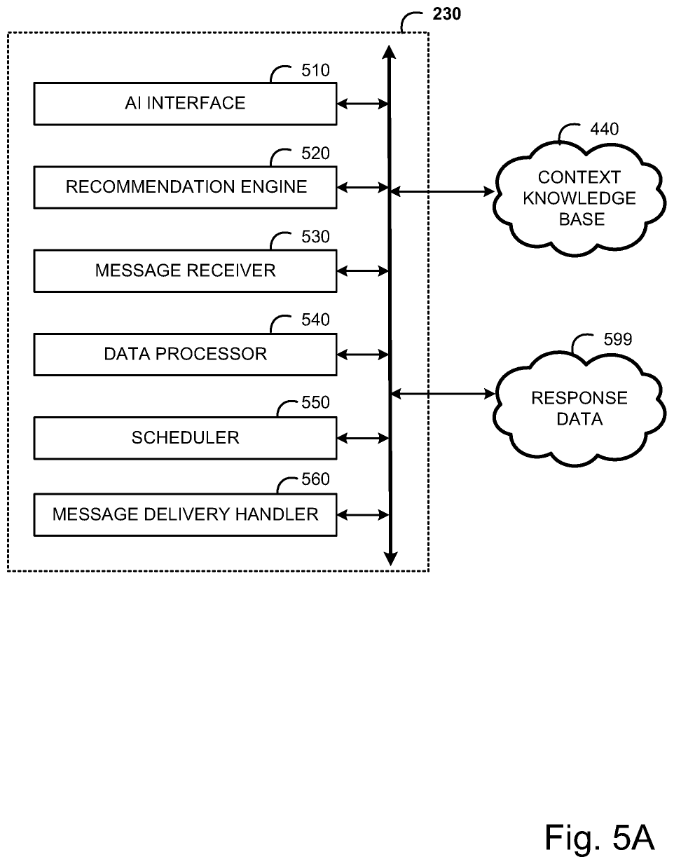

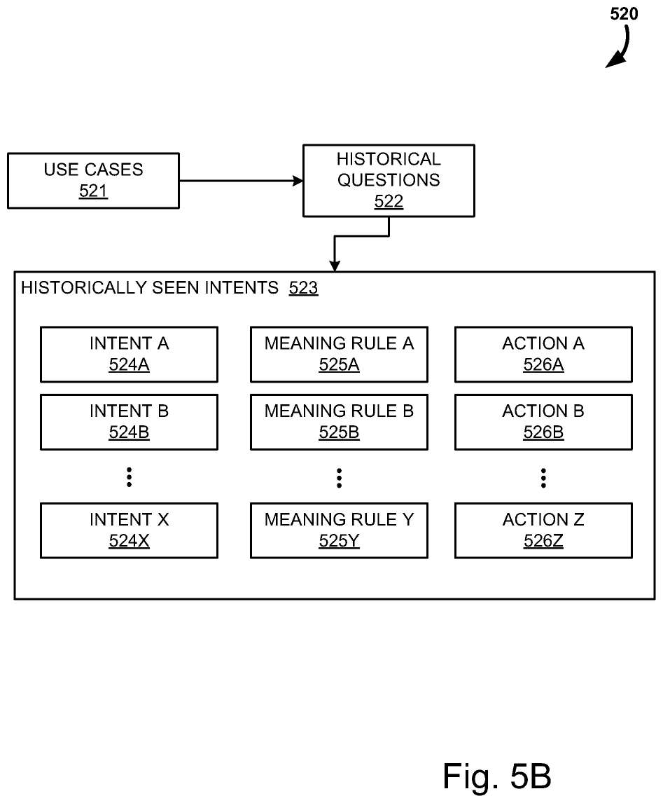

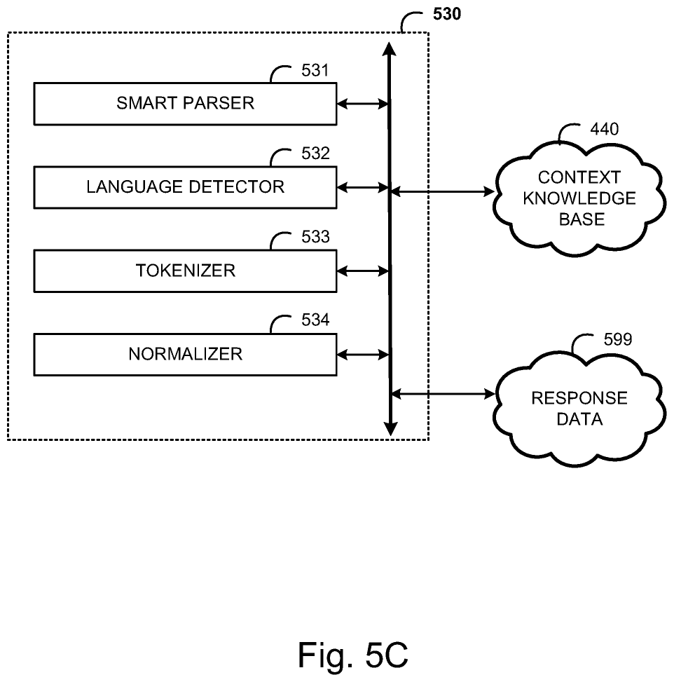

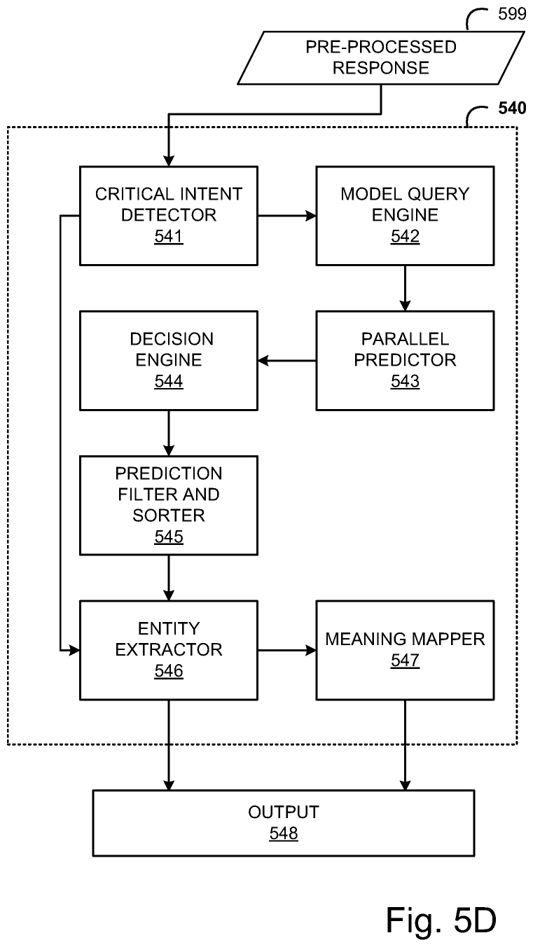

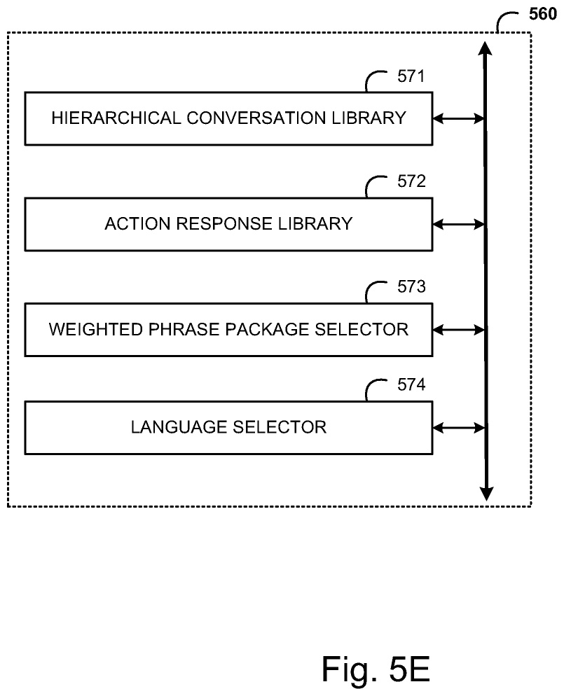

FIG. 5A is an example logical diagram of the message response system 230. In this example system, the contextual knowledge base 440 is utilized in combination with response data 599 received from the person being messaged (the target or recipient). The AI interface 510 receives the response data 599 and provides it to the message receiver 530 for preprocessing. Subsequently, a data processor 540 includes a suite of tools that enable classification of the messages using machine learned models, and based on the classifications generated by the AI and classification tools, target objectives may be updated and the subsequent actions to be taken may be determined. A scheduler 550 may coordinate the execution of these determined activities, while a message delivery handler 560 may interface with third party email systems to deliver response messages.

The message delivery handler 560 enables not only the delivery of the generated responses, but also may effectuate the additional actions beyond mere response delivery. The message delivery handler 560 may include phrase selections, contextualizing the response by historical activity, through language selection, and execute additional actions like status updates, appointment setting, and the like.

A recommendation engine 520 may enable a user of the system to leverage historical data for the recommendation of statements, questions and commands, resulting intents, actions to be taken and rules that link the intents to the specific actions for the generation of models that are particularly responsive to the present use case. The recommendation engine 520 also allows a relatively unsophisticated user of the system to generate rules that enable the conversation to operate in a more contextual and “natural” manner.

Turning to FIG. 5B, the recommendation engine 520 is provided in greater detail. As mentioned, one or more use cases 521 may be presented to the user. Each use case may include an industry selection, and selected language, at a minimum. The user selects the most appropriate use case for the generation of recommendations. This results in historical master “statements, questions and commands” 522 of the selected use case to be provided to the user.

These “master statements, questions and commands” are information that the system is trying to elicit and determine as part of the conversation. For example, a person's interest level in a particular product or service may be a common statement, question or command within a sales conversation. A target's willingness and desired time for a meeting would be another common set of statements, questions and commands. The “intents” that are derived are answers to these statements, questions and commands. For example, if a user has already purchased a similar product, this intent of “already purchased” may answer the statement, question or command of “is the person interested in XYZ product?”

The user is again able to select relevant statements, questions and commands from this listing of historical statements, questions and commands within the recommendation engine 520. In some embodiments, the user may likewise be able to input newly derived statements, questions and commands, or select pre-generated statements, questions and commands not necessarily associated with the use case via a search tool of all available statements, questions and commands.

The selected statements, questions and commands are linked automatically to historically predicted intents 523 (based upon historical model results). The individual intents 524a-x are presented, and the user may likewise be able to input additional new intents, if needed. Any newly generated intent requires a training exercise to generate the appropriate model for classification of a message segment into the intent. Such a training step would be completed subsequent to the recommendation engine operation in a backend process.

The intents 524a-x are linked to meanings 525a-y via meaning rules. The user may edit these meaning combination rules, if desired, and directly links the intents 524a-x each to a single action 526a-z. Each action 526a may be linked to multiple intents 524a-x, but not the other way around. These linkages provide the rules for treatment of conversations after classification.

On the backend, the system may collect responses from conversation target(s) over time. Once enough numbers of responses have been collected that are associated with a particular statement, question or command, topic modeling is performed on these responses, and the intents are associated with these responses. If all topics in the response have intents, the list of intents for the statement, question or command associated with the response may be compared against a list of intents for a master statement, question or command. If these match, then the master statement, question or command is suggested. However, if these isn't a match, or if not all topics include an intent, the system may undergo an additional master statement, question or command creation process.

In this statement, question or command generation process the user is asked to suggest a new master statement, question or command that has intents identified for it. These intents are then associated with currently available intents (those already modeled for), and the meaning combination rules are confirmed with the user.

Turning to FIG. 5C, the message receiver 530 is presented in greater detail. The message receiver 530 may include a smart parser 531 which consumes the raw message and splits it into multiple portions, including differentiating between the salutation, reply, close, signature and other message components. This is performed by the search and removal of the outgoing message (in an email this is typically appended below a response message and should mirror the message sent originally to the contact), followed by preprocessing of the test to build features. Subsequently predictions are requested by models for what message segment a particular line of text belongs to, and the response is logically built.

Each line of the raw message is classified on a line-by-line basis by a logical regression model. The model consumer the message ‘features’ that include both words/n-grams and placeholder elements. Examples of placeholder elements include “name_present”, “date_present” and similar logical variables. The construction of models that consume both n-gram data and placeholder elements has greater accuracy over traditional models in that it is able to generalize for message elements that would normally cause model confusion. For example, a traditional message segment classifier would likely have an error when a current date is encountered unless the model is updated daily and trained on the current date. In contrast, the present placeholder based model will more readily identify this to indicate a header/salutation of the message, whereas a non-present date would be indicative of message body content, for example.

After each line of the message has been classified, the conglomerate of classifications are passed through a series of logical statements to be divided into the categories of “salutation”, “reply”, “close”, “signature” and “other”.

The input for the smart parser, again, may include raw email text (or other message information converted into a raw text format). For example, the input into the smart parser function may include:

```
{
  “timestamp”: “2017-08-25 14:46:40”,
  “step”: “4”,
  “prospect_id”: “953346”,
  “campaign_id”: “422”,
  “messagebody”: “A la brevedad contestaremos tu correo\r\n\r\nEVELYN
ROJO CUETO\r\nGERENTE
GENERAL\r\nWWW.BASMAR.CL<http://www.BASMAR.CL>\r\nWWW.NOVEDADESCHARLOTT
E.JIMDO.COM<http://www.NOVEDADESCHARLOTTE.JIMDO.COM>\r\n(56)41-3236141
/ 94960666”
}
```

The output of the smart parser is again a breakdown of the message into the constituent parts. An example of such an output could include the following:

```
{
  “timestamp”: “2017-08-25 14:46:40”,
  “campaign_id”: “422”,
  “step”: “4”,
  “other”: “WWW.BASMAR.CL<http://www.BASMAR.CL”,
  “signature”: “EVELYN ROJO CUETO GERENTE GENERAL”,
  “salutation”: “ ”,
  “close”: “ ”,
  “prospect_id”: “953346”,
  “raw_text”: “A la brevedad contestaremos tu correo”
}
```

After the smart parser 531 is a language detector 532 which detects the language used in the raw text resulting from the smart parser 531. This language test is run against multiple language models, and the highest scoring model is selected as the model language. A binary confidence level—either ‘confident’ or ‘not confident’ is also output if the model score is above a configured threshold. For example, it the output from the smart parser 531 is the same as the above example, the resulting output after language detection could include the following:

```
{
  “language”: “spanish”,
  “timestamp”: “2017-08-25 14:46:40”,
  “campaign_id”: “422”,
  “step”: “4”,
  “other”: “WWW.BASMAR.CL<http://www.BASMAR.CL”,
  “signature”: “EVELYN ROJO CUETO GERENTE GENERAL”,
  “salutation”: “ ”,
  “close”: “ ”,
  “language_confidence”: “not confident”,
  “prospect_id”: “953346”,
  “raw_text”: “A la brevedad contestaremos tu correo”
}
```

After language detection, a tokenizer 533 divides the raw text into individual sentences. The motivation behind this preprocessing is to divide the prospect's response into separate ideas (usually indicated grammatically by sentences) and later predict meanings/intends at the more granular sentence level. This prevents the words/grams/features in one idea from contaminating/creating noise in the prediction of a second idea. The input for this tokenizer 533 may include the output from the language detector 532, and the output may break apart the text into individual sentence components. For the above example, the output would be as follows:

```
{
  “language”: “spanish”,
  “timestamp”: “2017-08-25 14:46:40”,
  “sentences”: [
    “A la brevedad contestaremos tu correo”
  ],
  “campaign_id”: “422”,
  “step”: “4”,
  “other”: “WWW.BASMAR.CL<http://www.BASMAR.CL”,
  “signature”: “EVELYN ROJO CUETO GERENTE GENERAL”,
  “salutation”: “ ”,
  “close”: “ ”,
  “language_confidence”: “not confident”,
  “prospect_id”: “953346”,
  “raw_text”: “A la brevedad contestaremos tu correo”
}
```

Subsequent to the tokenization, a normalizer 534 generates three new variables for the message. These include a classified text, clean text and the raw text. These different versions are each consumed in later operations. To make the best predictions of intents and meanings in the message, the system should eliminate possible sources of noise. Logic relating to lowercase strings, splitting the text into tokens, looking for entities with special expressions, replacement of these entities with special elements, removal of stopwords, removal of Conversica stopwords, and string normalization results in the return of classification text. Once the normalization process is completed a new clean string is generated to be sent to the next step plus other variables that may be stored. The input for the normalization process may be the same as the tokenizer output. The result of the normalization process may be as follows:

```
{
  “classification_text”: [
    “brevedad contestaremos correo”
  ],
  “language”: “spanish”,
  “timestamp”: “2017-08-25 14:46:40”,
  “signature”: “EVELYN ROJO CUETO GERENTE GENERAL”,
  “campaign_id”: “422”,
  “step”: “4”,
  “other”: “WWW.BASMAR.CL<http://www.BASMAR.CL”,
  “sentences”: [
    “A la brevedad contestaremos tu correo”
  ],
  “salutation”: “ ”,
  “close”: “ ”,
  “language_confidence”: “not confident”,
  “prospect_id”: “953346”,
  “raw_text”: “A la brevedad contestaremos tu correo”,
  “clean_text”: [
    “a la brevedad contestaremos tu correo”
  ]
}
```

After the raw text has been received and pre-processed in the above manner, the data processor 540 performs the main analysis on the message data. The data processor 540 is provided in greater detail in relation to FIG. 5D. In this component, data is processed to build features for classification text—these are standard text and language features: ngrams, stems and POS tags. The data processor includes an initial function (not illustrated) which, in some embodiments, may utilize external taggers, all included in the lambda function. This data processor function also contains a tagger for each of the supported languages. Example output for this example lambda function is the following:

```
{
  “campaign_id”: “422”,
  “sentences”: [
    “A la brevedad contestaremos tu correo”
  ],
  “salutation”: “ ”,
  “close”: “ ”,
  “prospect_id”: “953346”,
  “token_bigrams”: [
    “#_A A_la la_brevedad brevedad_contestaremos contestaremos_tu
tu_correo”
  ],
  “positive”: “0”,
  “negative”: “0”,
  “other”: “WWW.BASMAR.CL<http://www.BASMAR.CL”,
  “clean_text”: [
    “a la brevedad contestaremos tu correo”
  ],
  “language_confidence”: “not confident”,
  “token_length”: [
    “6”
  ],
  “timestamp”: “2017-08-25 14:46:40”,
  “stem_bigrams”: [
    “#_a a_la la_breved breved_contest contest_tu tu_corre”
  ],
  “tokens”: [
    “A la brevedad contestaremos tu correo”
  ],
  “step”: “4”,
  “stems”: [
    “a la breved contest tu corre”
  ],
  “classification_text”: [
    “brevedad contestaremos correo”
  ],
  “raw_text”: “A la brevedad contestaremos tu correo”,
  “language”: “spanish”,
  “neutral”: “1”,
  “signature”: “EVELYN ROJO CUETO GERENTE GENERAL”
}
```

The pre-processed response 599 that results from the function is provided next to a critical intent detector 541 which is applied to all incoming message. The critical intent detector's 541 purpose is to find critical (special case) scenarios that occur across the system regardless of client/industry/date/etc. These may include situations like “do not contact”, “out of office” and “spam detection”. The critical intent detector 541 is flexible to allow any intent to be designated as critical by adding it to a table in a relational database where the intent is declared with the name. Continuing our example, the pre-processed response provided in the prior example would result in an output of the critical intent detector 541 as follows:

```
{
  “campaign_id”: “422”,
  “sentences”: [
    “A la brevedad contestaremos tu correo”
  ],
  “salutation”: “ ”,
  “close”: “ ”,
  “prospect_id”: “953346”,
  “confidence”: 0.9942733915522695,
  “token_bigrams”: [
    “#_A A_la la_brevedad brevedad_contestaremos contestaremos_tu
tu_correo”
  ],
  “positive”: “0”,
  “negative”: “0”,
  “other”: “WWW.BASMAR.CL<http://www.BASMAR.CL”,
  “clean_text”: [
    “a la brevedad contestaremos tu correo”
  ],
  “language_confidence”: “not confident”,
  “token_length”: [
    “6”
  ],
  “timestamp”: “2017-08-25 14:46:40”,
  “stem_bigrams”: [
    “#_a a_la la_breved breved_contest contest_tu tu_corre”
  ],
  “tokens”: [
    “A la brevedad contestaremos tu correo”
  ],
  “neutral”: “1”,
  “stems”: [
    “a la breved contest tu corre”
  ],
  “classification_text”: [
    “brevedad contestaremos correo”
  ],
  “raw_text”: “A la brevedad contestaremos tu correo”,
  “language”: “spanish”,
  “step”: “4”,
  “critical_intent_detected”: “False”,
  “signature”: “EVELYN ROJO CUETO GERENTE GENERAL”
}
```

In this output example, a determination of any critical intent being present was determined to be negative (“false”), meaning that the response processing is forwarded to a model query engine 542 for additional analysis. Had a critical intent been detected, the system would have rather immediately provided the response to the entity extractor 546 for entity extraction and output 548 generation.

Entities may include people, objects, locations, phone numbers, email addresses, dates, businesses and the like. Intents, on the other hand, are coded based upon business needs, or may be identified automatically through training or through interaction with a training desk. Particular intents of interest for a business conversation could include, for example, satisfied, disqualified, no further action and further action, in some embodiments. These intents may correspond to situations where the goals for a conversation target have been met (satisfied intent), where such goals are unable to be met (disqualified), where the goal is in progress without need for additional messaging (no further action), and where the goal is in process but requires additional information or messaging to be fully resolved (further action).

The model query engine 542 pulls all models declared in a table for the response situation (industry, client, campaign, etc.). The model query engine 542 executes checks to ensure that it is utilizing the most current version of a query function which has a viable endpoint. This function returns a list of models with their ID and their label translation (from binary to meaning). The input into the model query engine may include the previous output that has been n-gram parsed and tagged accordingly. The output includes the model listing with results of intents determined by the models, such as “satisfied” or “not interested”.

Subsequently, the system includes a parallel predictor 543 which elicits predictions from all models available in the input to all of the “clean_text” instances availed. The parallel predictor 543 returns a list of the highest scoring predictions across all the sentences, with their labels mapped to the meanings. For example, if a message contains three sentences and the predictions for the meaning is “call by phone” for sentence 1 is a 0.23 probability, sentence 2 is a 0.18 probability, and for sentence 3 a 0.93 probability, then the prediction score for the meaning “call by phone” will be 0.93 (e.g., the maximum of the multiple scores).

The input to the parallel predictor 543 is a combination of the model query engine 542 output and the n-gram information previously illustrated. This results in meanings attributed to the models being scored as a probability of being accurate. For example, the output may include the model identifier and a finding such as “confirm address” at 98%, all the way down to a finding of “none” for the meaning at 0.5% in some example situation.

After parallel prediction the system processes the outputs in a decision engine 544. The decision engine 544 analyzes the text with a set of hard-coded rules. The purpose of this analysis is to prevent trivial errors from happening. If the function does identify a meaning within the text it will remove that model from the “model-query-list” as to not waste time predicting meanings for which there is already an answer and place the prediction (with a score of 1) within the “prediction” section of the event. The input of the decision engine 544 is the output of the parallel predictor 543. The output of the decision engine's 544 processing may include the same layout, with models identifiers, associated intents and probabilities of the intent being true, just with some of these probabilities set to “1” based upon the decision engine's findings.

Following the decision engine 544 is a prediction filter and sorter 545 which sorts the predictions based upon confidence scores/levels (placing the highest confidences on the top), and filters out predictions where “none” is indicated (the intent is not predicted in the message). This sorting and filtering cleans the prediction dataset, and the information may be stored, along with attendant meanings and their corresponding scores.

After filtering and sorting, entity extraction is performed by the entity extractor 546. As noted previously, if a critical intent was found earlier, the system also immediately would forward to the entity extractor 546 as well. Examples of entities that may be extracted from the raw text could include product brands, product models, emails, phone numbers, Urls, cities, countries, districts, and the like. Input to the entity extractor 546 may depend if the input originates from the prediction filter and sorter 545 or the critical intent detector 541. Regardless, the output that is generated includes an extracted entity field.

Lastly, after entity extraction, analysis is performed by a meaning mapper 547 to generate an output 548 of the data processor 540. The meaning mapper 547 maps the intents identified in the conversation to meanings. The mapping is between all the predictions available in the response and the meanings as a list in a relational database table. Here candidates are created by a system administrator, and these candidates are attached to their scores, if one is higher than another and it is available in the table then it is used to return to the workflow of the prospect. In some embodiments, the meaning mapper 547 also defines which messages are going to manual evaluation or automatic evaluation based on the threshold set for each meaning or intent definition in the relational database. The output of the meaning mapper 547 is shorter than prior components, as only probable meanings are included, such as “still looking to purchase” or “wrong contact” for example.

As noted before, the entire data processor 540 operates as a step function responsible for connecting all of the lambda functions. The step function may start with the smart message parser, proceed to message normalization, then language detection, and then data processing, which includes its own stepwise sets of functions (e.g., critical intent checking, model query, parallel prediction, sorting, meaning mapping, etc.).

Turning to FIG. 5D, the message delivery handler 560 is presented in greater detail. The message delivery handler 560 receives output from the data processor 540 and performs its own processing to arrive at the final outgoing message. The message delivery handler 560 may include a hierarchical conversation library 571 for storing all the conversation components for building a coherent message. The hierarchical conversation library 571 may be a large curated library, organized and utilizing multiple inheritance along a number of axes: organizational levels, access-levels (rep→group→customer→public). The hierarchical conversation library 571 leverages sophisticated library management mechanisms, involving a rating system based on achievement of specific conversation objectives, gamification via contribution rewards, and easy searching of conversation libraries based on a clear taxonomy of conversations and conversation trees.

In addition to merely responding to a message with a response, the message delivery handler 560 may also include a set of actions that may be undertaken linked to specific triggers, these actions and associations to triggering events may be stored in an action response library 572. For example, a trigger may include “Please send me the brochure.” This trigger may be linked to the action of attaching a brochure document to the response message, which may be actionable via a webhook or the like. The system may choose attachment materials from a defined library (SalesForce repository, etc.), driven by insights gained from parsing and classifying the previous response, or other knowledge obtained about the target, client, and conversation. Other actions could include initiating a purchase (order a pizza for delivery for example) or pre-starting an ancillary process with data known about the target (kick of an application for a car loan, with name, etc. already pre-filled in for example). Another action that is considered is the automated setting and confirmation of appointments.

The message delivery handler 560 may have a weighted phrase package selector 573 that incorporates phrase packages into a generated message based upon their common usage together, or by some other metric.

Lastly, the message delivery handler 560 may operate to select which language to communicate using. In prior disclosures, it was noted that embodiments of the AI classification system systems may be enabled to perform multiple language analysis. Rather than perform classifications using full training sets for each language, as is the traditional mechanism, the systems leverage dictionaries for all supported languages, and translations to reduce the needed level of training sets. In such systems, a primary language is selected, and a full training set is used to build a model for the classification using this language. Smaller training sets for the additional languages may be added into the machine learned model. These smaller sets may be less than half the size of a full training set, or even an order of magnitude smaller. When a response is received, it may be translated into all the supported languages, and this concatenation of the response may be processed for classification. The flip side of this analysis is the ability to alter the language in which new messages are generated. For example, if the system detects that a response is in French, the classification of the response may be performed in the above-mentioned manner, and similarly any additional messaging with this contact may be performed in French.

Determination of which language to use is easiest if the entire exchange is performed in a particular language. The system may default to this language for all future conversation. Likewise, an explicit request to converse in a particular language may be used to determine which language a conversation takes place in. However, when a message is not requesting a preferred language, and has multiple language elements, the system may query the user on a preferred language and conduct all future messaging using the preferred language.

### II. Methods

Now that the systems for dynamic messaging and natural language processing techniques have been broadly described, attention will be turned to processes employed to perform AI driven conversations with attendant actions.

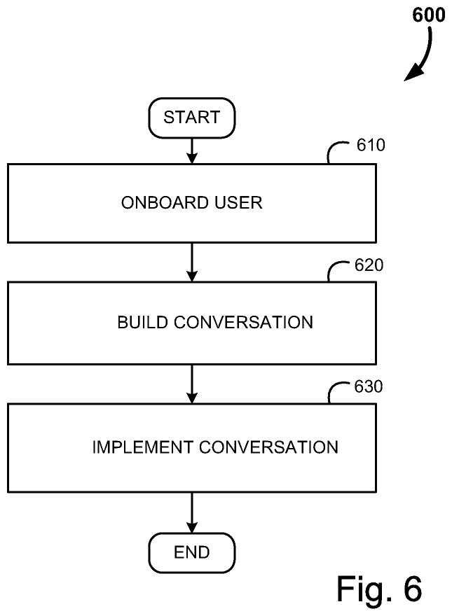

In FIG. 6 an example flow diagram for a dynamic message conversation is provided, shown generally at 600. The process can be broadly broken down into three portions: the on-boarding of a user (at 610), conversation generation (at 620) and conversation implementation (at 630). The following figures and associated disclosure will delve deeper into the specifics of these given process steps.

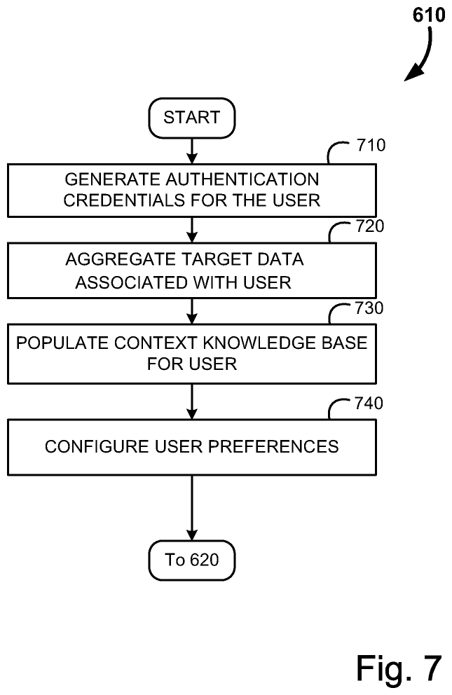

FIG. 7, for example, provides a more detailed look into the on-boarding process, shown generally at 610. Initially a user is provided (or generates) a set of authentication credentials (at 710). This enables subsequent authentication of the user by any known methods of authentication. This may include username and password combinations, biometric identification, device credentials, etc.

Next, the target data associated with the user is imported, or otherwise aggregated, to provide the system with a target database for message generation (at 720). Likewise, context knowledge data may be populated as it pertains to the user (at 730). Often there are general knowledge data sets that can be automatically associated with a new user; however, it is sometimes desirable to have knowledge sets that are unique to the user's conversation that wouldn't be commonly applied. These more specialized knowledge sets may be imported or added by the user directly.

Lastly, the user is able to configure their preferences and settings (at 740). This may be as simple as selecting dashboard layouts, to configuring confidence thresholds required before alerting the user for manual intervention.

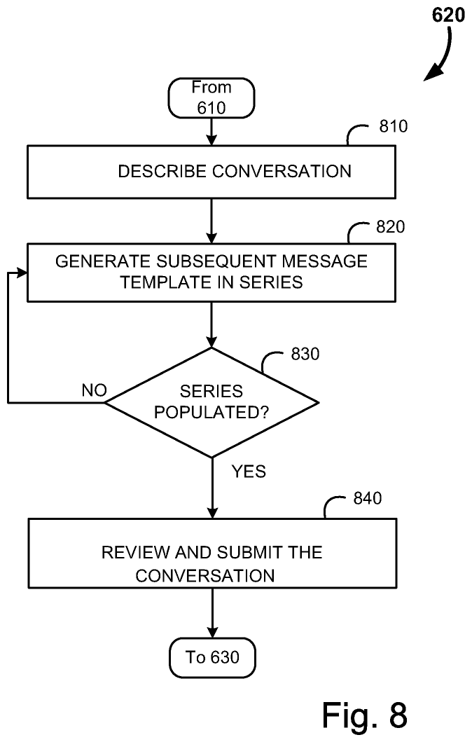

Moving on, FIG. 8 is the example flow diagram for the process of building a conversation, shown generally at 620. The user initiates the new conversation by first describing it (at 810). Conversation description includes providing a conversation name, description, industry selection, and service type. The industry selection and service type may be utilized to ensure the proper knowledge sets are relied upon for the analysis of responses.

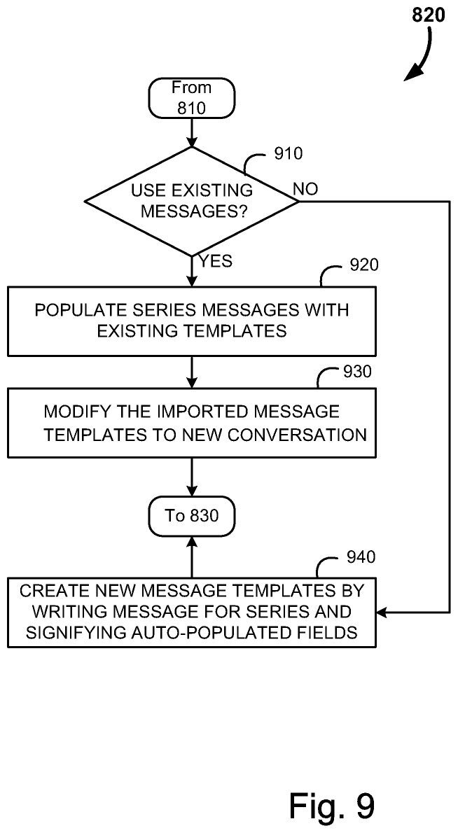

After the conversation is described, the message templates in the conversation are generated (at 820). If the series is populated (at 830), then the conversation is reviewed and submitted (at 840). Otherwise, the next message in the template is generated (at 820). FIG. 9 provides greater details of an example of this sub-process for generating message templates. Initially the user is queried if an existing conversation can be leveraged for templates, or whether a new template is desired (at 910).

If an existing conversation is used, the new message templates are generated by populating the templates with existing templates (at 920). The user is then afforded the opportunity to modify the message templates to better reflect the new conversation (at 930). Since the objectives of many conversations may be similar, the user will tend to generate a library of conversations and conversation fragments that may be reused, with or without modification, in some situations. Reusing conversations has time saving advantages, when it is possible.

However, if there is no suitable conversation to be leveraged, the user may opt to write the message templates from scratch using the Conversation Editor (at 940). When a message template is generated, the bulk of the message is written by the user, and variables are imported for regions of the message that will vary based upon the target data. Successful messages are designed to elicit responses that are readily classified. Higher classification accuracy enables the system to operate longer without user interference, which increases conversation efficiency and user workload.

Messaging conversations can be broken down into individual objectives for each target. Designing conversation objectives allows for a smoother transition between messaging series. Table 1 provides an example set of messaging objectives for a sales conversation.

TABLE 1
Template Objectives

| Series | Objective |
|---|---|
| 1 | Verify Email Address |
| 2 | Obtain Phone Number |
| 2 | Introduce Sales Representative |
| 3 | Verify Rep Follow-Up |

Likewise, conversations can have other arbitrary set of objectives as dictated by client preference, business function, business vertical, channel of communication and language. Objective definition can track the state of every target. Inserting personalized objectives allows immediate question answering at any point in the lifecycle of a target. The state of the conversation objectives can be tracked individually as shown below in reference to Table 2.

TABLE 2
Objective tracking

| | Conver- | | | | |
|---|---|---|---|---|---|
| Target | sation | | | | |
| ID | ID | Objective | Type | Pending | Complete |
| 100 | 1 | Verify Email Address | Q | 1 | 1 |
| 100 | 1 | Obtain Phone Number | Q | 0 | 1 |
| 100 | 1 | Give Location Details | I | 1 | 0 |
| 100 | 1 | Verify Rep Follow-Up | Q | 0 | 0 |

Table 2 displays the state of an individual target assigned to conversation 1, as an example. With this design, the state of individual objectives depends on messages sent and responses received. Objectives can be used with an informational template to make a series transition seamless. Tracking a target's objective completion allows for improved definition of target's state, and alternative approaches to conversation message building. Conversation objectives are not immediately required for dynamic message building implementation but become beneficial soon after the start of a conversation to assist in determining when to move forward in a series.

Dynamic message building design depends on ‘message_building’ rules in order to compose an outbound document. A Rules child class is built to gather applicable phrase components for an outbound message. Applicable phrases depend on target variables and target state.

To recap, to build a message, possible phrases are gathered for each template component in a template iteration. In some embodiment, a single phrase can be chosen randomly from possible phrases for each template component. Alternatively, as noted before, phrases are gathered and ranked by “relevance”. Each phrase can be thought of as a rule with conditions that determine whether or not the rule can apply and an action describing the phrase's content.

Relevance is calculated based on the number of passing conditions that correlate with a target's state. A single phrase is selected from a pool of most relevant phrases for each message component. Chosen phrases are then imploded to obtain an outbound message. Logic can be universal or data specific as desired for individual message components.

Variable replacement can occur on a per phrase basis, or after a message is composed. Post message-building validation can be integrated into a message-building class. All rules interaction will be maintained with a messaging rules model and user interface.

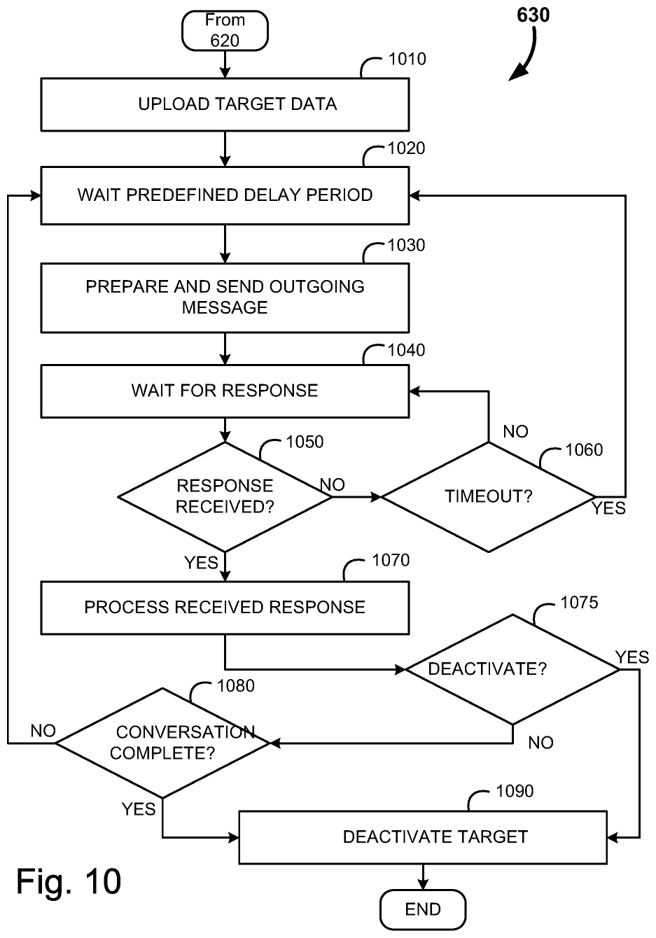

Once the conversation has been built out it is ready for implementation. FIG. 10 is an example flow diagram for the process of implementing the conversation, shown generally at 630. Here the lead (or target) data is uploaded (at 1010). Target data may include any number of data types, but commonly includes names, contact information, date of contact, item the target was interested in (in the context of a sales conversation), etc. Other data can include open comments that targets supplied to the target provider, any items the target may have to trade in, and the date the target came into the target provider's system. Often target data is specific to the industry, and individual users may have unique data that may be employed.

An appropriate delay period is allowed to elapse (at 1020) before the message is prepared and sent out (at 1030). The waiting period is important so that the target does not feel overly pressured, nor the user appears overly eager. Additionally, this delay more accurately mimics a human correspondence (rather than an instantaneous automated message). Additionally, as the system progresses and learns, the delay period may be optimized by a cadence optimizer to be ideally suited for the given message, objective, industry involved, and actor receiving the message.

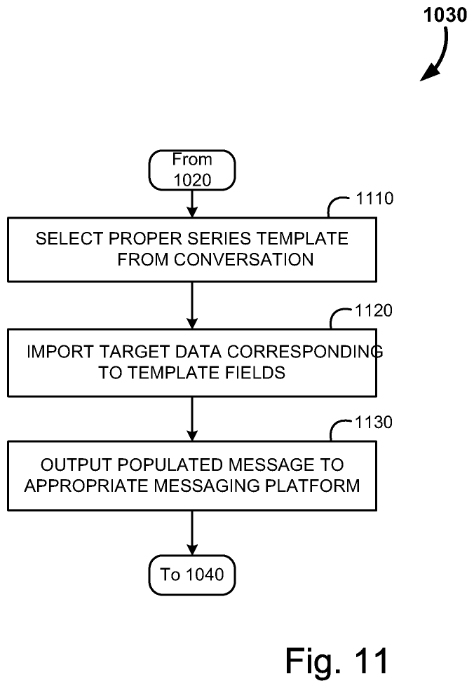

FIG. 11 provides a more detailed example of the message preparation and output. In this example flow diagram, the message within the series is selected based upon which objectives are outstanding (at 1110). Typically, the messages will be presented in a set order; however, if the objective for a particular target has already been met for a given series, then another message may be more appropriate. Likewise, if the recipient didn't respond as expected, or not at all, it may be desirous to have alternate message templates to address the target most effectively.

After the message template is selected from the series, the target data is parsed through, and matches for the variable fields in the message templates are populated (at 1120). Variable filed population, as touched upon earlier, is a complex process that may employ personality matching, and weighting of phrases or other inputs by success rankings. These methods will also be described in greater detail when discussed in relation to variable field population in the context of response generation. Such processes may be equally applicable to this initial population of variable fields.

In addition, or alternate to, personality matching or phrase weighting, selection of wording in a response could, in some embodiments, include matching wording or style of the conversation target. People, in normal conversation, often mirror each other's speech patterns, mannerisms and diction. This is a natural process, and an AI system that similarly incorporates a degree of mimicry results in a more ‘humanlike’ exchange.

Additionally, messaging may be altered by the class of the audience (rather than information related to a specific target personality). For example, the system may address an enterprise customer differently than an individual consumer. Likewise, consumers of one type of good or service may be addressed in subtly different ways than other customers. Likewise, a customer service assistant may have a different tone than an HR assistant, etc.

The populated message is output to the communication channel appropriate messaging platform (at 1130), which as previously discussed typically includes an email service, but may also include SMS services, instant messages, social networks, audio networks using telephony or speakers and microphone, or video communication devices or networks or the like. In some embodiments, the contact receiving the messages may be asked if he has a preferred channel of communication. If so, the channel selected may be utilized for all future communication with the contact. In other embodiments, communication may occur across multiple different communication channels based upon historical efficacy and/or user preference. For example, in some particular situations a contact may indicate a preference for email communication. However, historically, in this example, it has been found that objectives are met more frequently when telephone messages are utilized. In this example, the system may be configured to initially use email messaging with the contact, and only if the contact becomes unresponsive is a phone call utilized to spur the conversation forward. In another embodiment, the system may randomize the channel employed with a given contact, and over time adapt to utilize the channel that is found to be most effective for the given contact.

Returning to FIG. 10, after the message has been output, the process waits for a response (at 1040). If a response is not received (at 1050) the process determines if the wait has been timed out (at 1060). Allowing a target to languish too long may result in missed opportunities; however, pestering the target too frequently may have an adverse impact on the relationship. As such, this timeout period may be user defined and will typically depend on the communication channel. Often the timeout period varies substantially, for example for email communication the timeout period could vary from a few days to a week or more. For real-time chat communication channel implementations, the timeout period could be measured in seconds, and for voice or video communication channel implementations, the timeout could be measured in fractions of a second to seconds. If there has not been a timeout event, then the system continues to wait for a response (at 1050). However, once sufficient time has passed without a response, it may be desirous to return to the delay period (at 1020) and send a follow-up message (at 1030). Often there will be available reminder templates designed for just such a circumstance.

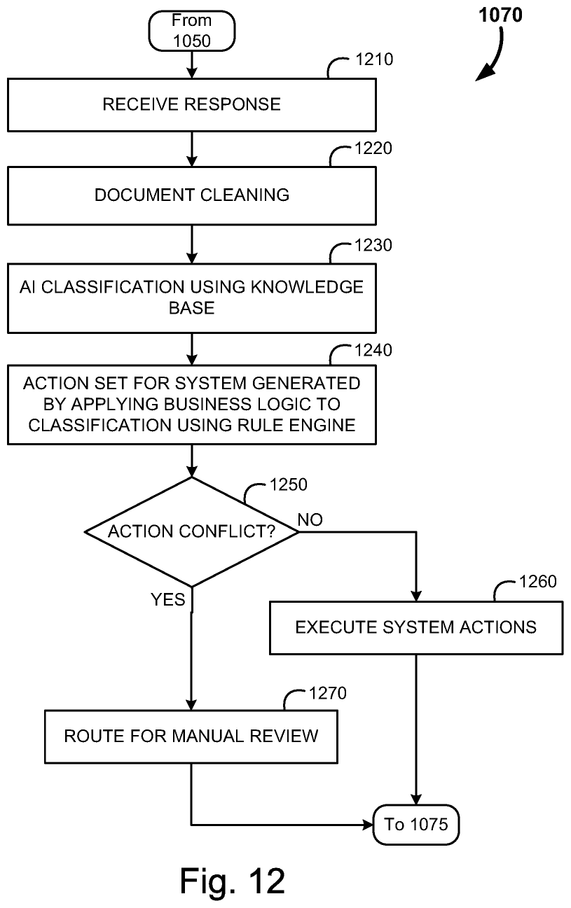

However, if a response is received, the process may continue with the response being processed (at 1070). This processing of the response is described in further detail in relation to FIG. 12. In this sub-process, the response is initially received (at 1210) and the document may be cleaned (at 1220).

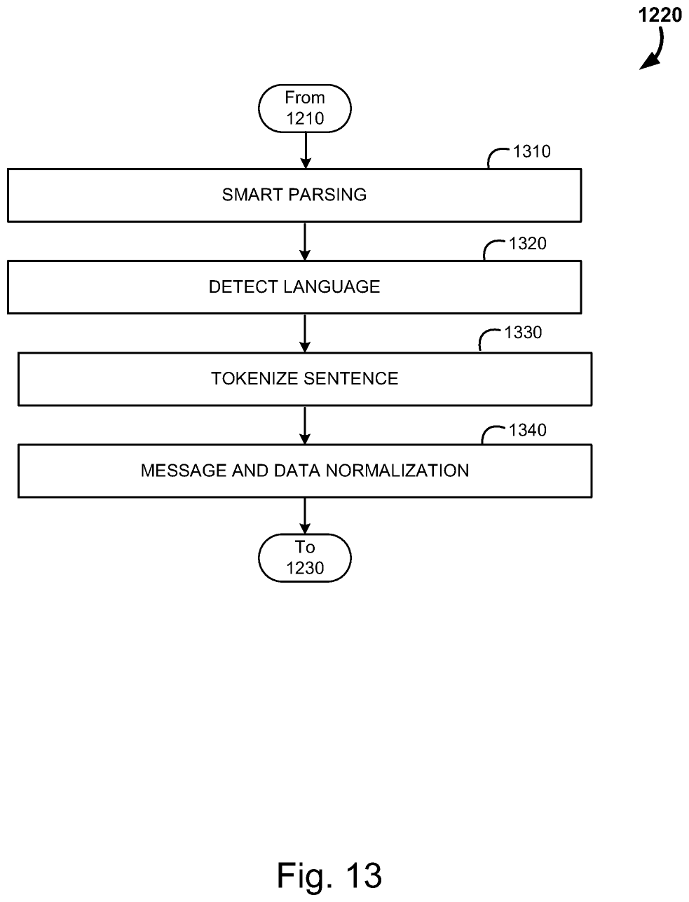

Document cleaning is described in greater detail in relation with FIG. 13. Upon document receipt, adapters may be utilized to extract information from the document for shepherding through the cleaning and classification pipelines. For example, for an email, adapters may exist for the subject and body of the response, often a number of elements need to be removed, including the original message, HTML encoding for HTML style responses, enforce UTF-8 encoding so as to get diacritics and other notation from other languages, and signatures so as to not confuse the AI. An initial step of the document preprocessing/cleaning process is the smart parsing (at 1310) of the document into constituent portions. As discussed previously, this may include breaking the raw text of the message into a salutation, body/reply, close, signature and other category. This process includes the removal of outgoing message components, preprocessing text and build features, as previously discussed, and asking for predictions.

After smart parsing, the system may detect the language (at 1320) of the response using multiple language models and selecting the model with the highest confidence level. Next, the sentences are tokenized (at 1330) which divides the response into separate sentences. This is performed because generally each sentence of a conversation includes a separate/discrete idea or intention. By separating each sentence the risk of token contamination between the sentences is reduced. Only after all this does the normalization process occur (at 1340) where characters and tokens are removed in order to reduce the complexity of the document without changing the intended classification.

After the normalization, documents are further processed through lemmatization, name entity replacement, the creation of n-grams, noun-phrase identification, and extraction of out-of-office features and/or other named entity recognition. Each of these steps may be considered a feature extraction of the document. Historically, extractions have been combined in various ways, which results in an exponential increase in combinations as more features are desired. In response, the present method performs each feature extraction in discrete steps (on an atomic level) and the extractions can be “chained” as desired to extract a specific feature set.

Returning to FIG. 12, after document cleaning, the document is then provided to the AI platform for classification using the knowledge sets/base (at 1230). For the purpose of this disclosure, a “knowledge set” is a corpus of domain specific information that may be leveraged by the machine learned classification model. The knowledge sets may include a plurality of concepts and relationships between these concepts. It may also include basic concept-action pairings. The AI Platform will apply large knowledge sets to classify ‘Continue Messaging’, ‘Do Not Email’ and ‘Send Alert’ insights. Additionally, various domain specific ‘micro-insights’ can use smaller concise knowledge sets to search for distinct elements in responses.

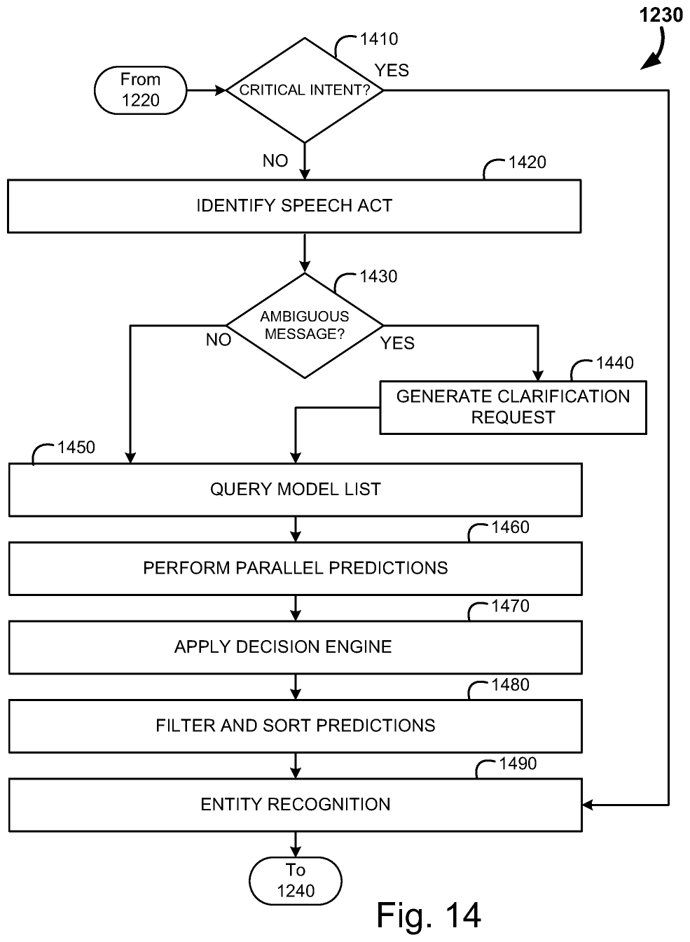

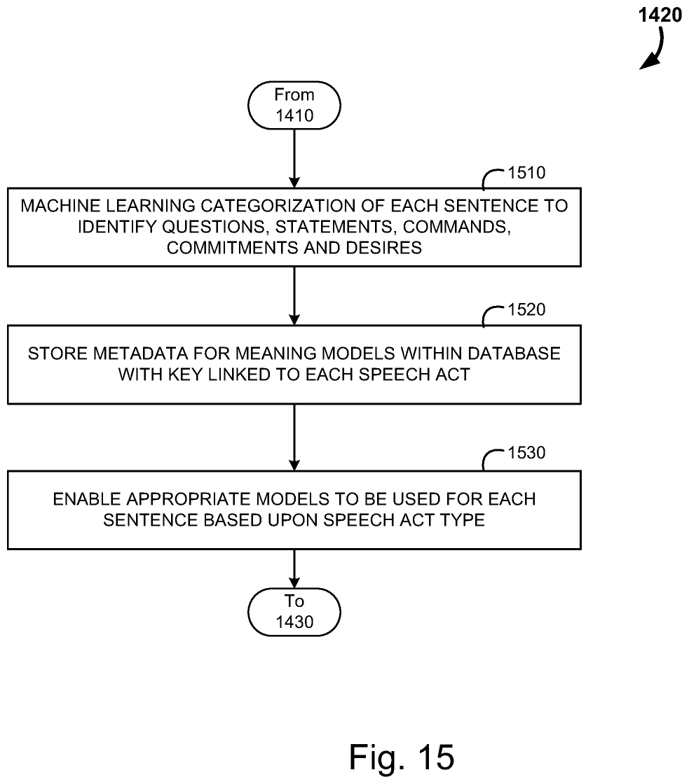

FIG. 14 provides a more detailed view of the classification step 1230. As previously touched upon, this includes an initial detection of possible critical intents (at 1410), which if present causes the process to immediately perform entity extraction (at 1490). However, if no such critical intent is present the next stage is to determine speech acts (at 1420). FIG. 15 provides greater detail into the identification of such speech acts. This sub-process includes performance of machine learning categorization of each sentence to classify it as either a question, statement, command, commitment or desire (at 1510). The identification of these speech acts enables better differentiation between the parallel prediction model results, as some models may perform significantly differently based upon if the sentence is a question versus a desire, for example. For the purposes of this disclosure, a speech act of a command is defined as an utterance that compels someone to perform an action. A question is an utterance that asks for information and/or an opinion. A statement is an utterance that merely conveys information and/or opinions. A desire is an utterance that conveys a desire or need that the agent has. And a commitment is an utterance that expresses a commitment to perform an action by an agent.

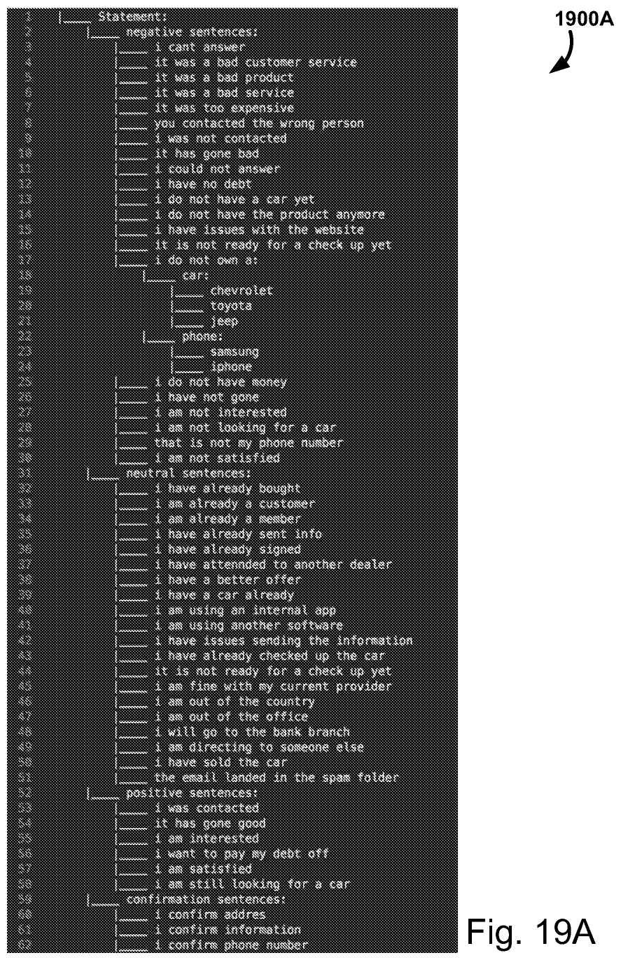

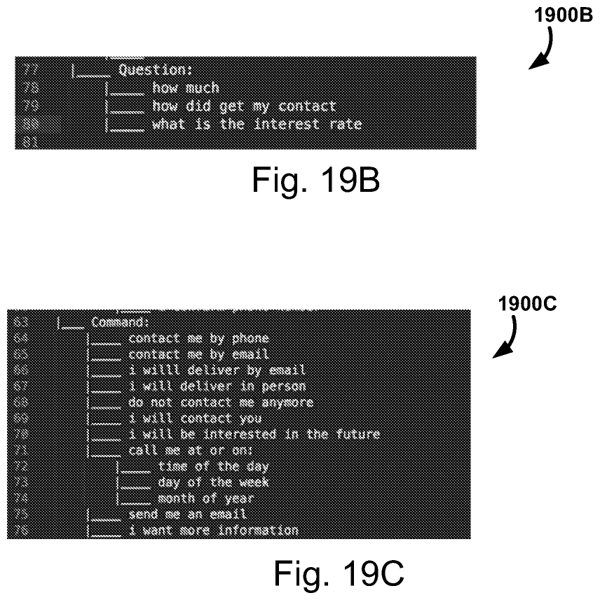

Each speech act includes its own feature set and models used for classification of sentences that fall into the given speech acts. The metadata of the meaning models is stored into the database containing a key that links to the correct speech act (at 1520). This generates a hierarchy on a meaning level using a more natural approach to the language, and enables appropriate models to be used for each sentence based upon it's respective speech act (at 1530). Examples of these meaning models for statements may be seen in the screenshot of an example hierarchy at 1900A of FIG. 19A. Similarly, example meaning hierarchies for statements, questions and commands and comments may be seen at 1900B and 1900C of FIGS. 19B and 19C respectively.

Returning to FIG. 14, after speech act identification an inquiry is made (at 1430) if the message is ambiguous. An ambiguous message is one for which a classification can be rendered at a high level of confidence, but which meaning is still unclear due to lack of contextual cues. Such ambiguous messages may be responded to by generating and sending a clarification request (at 1440).

However, if the message is not ambiguous, or after a clarification has been received, the process may proceed to a query of the model list (at 1450). This function pulls all models declared in a table for that situation (industry, client, campaign and speech act). It executes checks to ensure that it is the most current version and has a viable endpoint. Then the function returns a list of models with their ID and their label translation (from binary to meaning). Once the models have been identified, they may be executed in parallel to perform parallel predictions (at 1460). This component asks for predictions from all models available in the input to all of the “clean_text” instances availed. It will return a list of the highest scoring predictions across all the sentences with their labels mapped to the meanings.

Subsequently, decision engine may be applied (at 1470) which analyzes the text with a set of hard-coded rules. The purpose is to prevent silly errors from happening. If the function does identify a meaning within the text it will remove that model from the “model-query-list” as to not waste time predicting meanings for which there is already an answer and place the prediction (with a score of 1) within the “prediction” section of the event. Next, the predictions are filtered and sorted (at 1480). B Sorting and filtering places highest level predictions on the top of the prediction listing, and removes predictions of ‘none’ from the dataset. This process cleans up the prediction data. The results are then stored, along with the meanings and corresponding scores.

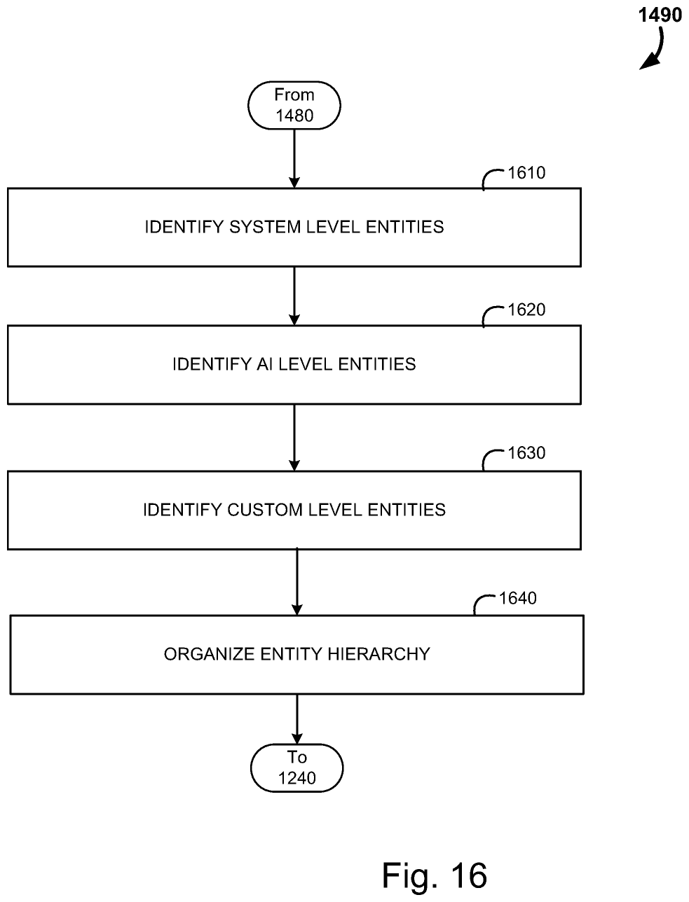

Next, entity recognition is performed (at 1490). A more detailed explanation of this entity recognition process is provided in relation to FIG. 16. Initially, system level entities are identified (at 1610), followed by AI level entities and custom level entities (at steps 1620 and 1630 respectively). The entities are then organized into a hierarchy (at 1640).

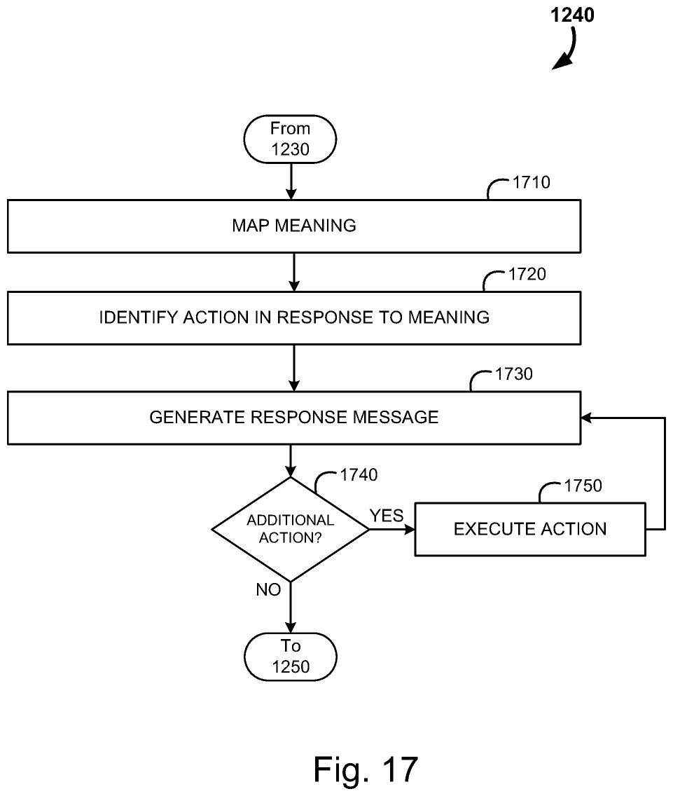

Returning to FIG. 12, after data processing has been performed, actions may be set by application of business logic to the classification (at 1240). This sub process is described in greater detail in relation to FIG. 17. A critical component of action determination is to map the intents predicted during classification to meanings (at 1710). The mapping engine includes a set of rules that are stored in a table at the creation of a conversation, which will be discussed in greater detail below. These rules map meanings to intents, and the intents are defined ad hoc by the person who is creating the conversation. The intents may be called as they need to be, or may be restricted to recommendations of ‘intents’ based on previous answers for a given statement, question or command (as discussed in relation to the recommendation engine). A few examples of the structure to map meanings (and entities) to intents, within the situation where the question is if the meaning is that the target is “interested in buying a car”, may include having a meaning of“interested” or “yes”, and an entity of the commercial item at interest (in this example a vehicle model), or a

In this example it may be seen how an intent “interested_buying_car” can be triggered by a combination of different meanings plus a set of entities and without the appearance of other set of meanings. The logic of “AND, OR, NOT” is part of the front-end of this process. As for the back-end, the resulting dictionary of rules is defined. For a given conversation, in a given step, the mapping will be in between intents to the actions. The set of rules map to current actions, but are also flexible enough to allow for the addition of any kind of action needed if the system supports it. The dictionary lies inside the same table and the structure to map “intents” to actions is provided in the following example:

{“hot_prospect”: [{“template_1”:
[“interested_buying_car”]}, {“template_2”:
[“want_more_information_through_email”]}], “prospect_out” :
[{“template_1”: [“not_interested_in_buying_car”]}]}

As an extension, a template key for each intent for a given action exists. This allows conversations to send prospects to the same actions but replies to them in a different way for different intents. In this manner actions may be identified that apply in response to the meaning (at 1720). This response is generated (at 1730) by identifying an appropriate response template, and populating the variable fields within the template. Population of the variable fields includes replacement of facts and entity fields from the conversation library based upon an inheritance hierarchy. The conversation library is curated and includes specific rules for inheritance along organization levels and degree of access. This results in the insertion of customer/industry specific values at specific place in the outgoing messages, as well as employing different lexica or jargon for different industries or clients. Wording and structure may also be influenced by defined conversation objectives and/or specific data or properties of the specific target.

Specific phrases may be selected based upon weighted outcomes (success ranks). The system calculates phrase relevance scores to determine the most relevant phrases given a lead state, sending template, and message component. Some (not all) of the attributes used to describe lead state are: the client, the conversation, the objective (primary versus secondary objective), series in the conversation and attempt number in the series, insights, target language and target variables. For each message component, the builder filters (potentially thousands of) phrases to obtain a set of maximum-relevance candidates. In some embodiments, within this set of maximum-relevance candidates, a single phrase is randomly selected to satisfy a message component. As feedback is collected, phrase selection is impacted by phrase performance over time, as discussed previously. In some embodiments, every phrase selected for an outgoing message is logged. Sent phrases are aggregated into daily windows by Client, Conversation, Series, and Attempt. When a response is received, phrases in the last outgoing message are tagged as ‘engaged’. When a positive response triggers another outgoing message, the previous sent phrases are tagged as ‘continue’. The following metrics are aggregated into daily windows: total sent, total engaged, total continue, engage ratio, and continue ratio.

To impact message-building, phrase performance must be quantified and calculated for each phrase. This may be performed using the following equation:

$$\begin{matrix}Phrase performance & \\ performance = \frac{( percent\_engaged + percent\_continue )}{2} & Equation 1\end{matrix}$$

Engagement and continuation percentages are gathered based on messages sent within the last 90 days, or some other predefined history period. Performance calculations enable performance-driven phrase selection. Relative scores within maximum-relevance phrases can be used to calculate a selection distribution in place of random distribution.

Phrase performance can fluctuate significantly when sending volume is low. To minimize error at low sending volumes, a

$$\frac{ln ( x )}{x}$$

padding window is applied to augment all phrase-performance scores. The padding is effectively zero when total_sent is larger than 1,500 sent messages. This padded performance is performed using the following equation:

$$\begin{matrix} Padded performance & \\ performance\_pad = 100 \times \frac{ln ( total\_sent + LN\_OFFSET )}{total\_sent + ZERO\_OFFSET} & Equation 2\end{matrix}$$

Performance scores are augmented with the performance pad prior to calculating distribution weights using the following equation:

performance′=performance+performance_pad Equation 3: Augmented phrase performance

As noted, phrase performance may be calculated based on metrics gathered in the last 90 days. That window can change to alter selection behavior. Weighting of metrics may also be based on time. For example, metrics gathered in the last 30 days may be assigned a different weight than metrics gathered in the last 30-60 days. Weighting metrics based on time may affect selection behaviors as well. Phrases can be shared across client, conversation series, attempt, etc. It should be noted that alternate mechanisms for calculating phrase performance are also possible, such as King of the Hill or Reinforcement Learning, deep learning, etc.

Due to the fact that message attempt is correlated with engagement; metrics are gathered per attempt to avoid introducing engagement bias. Additionally, variable values can impact phrase performance; thus, calculating metrics per client is done to avoid introducing variable value bias.

Adding performance calculations to message building increases the amount of time to build a single message. System improvements are required to offset this additional time requirement. These may include caching performance data to minimize redundant database queries, aggregating performance data into windows larger than one day, and aggregating performance values to minimize calculations made at runtime.

In addition to performance-based selection, as discussed above, phrase selection may be influenced by the “personality” of the system for the given conversation. Personality of an AI assistant may not just be set, as discussed previously, but may likewise be learned using machine learning techniques that determines what personality traits are desirable to achieve a particular goal, or that generally has more favorable results.

Message phrase packages are constructed to be tone, cadence, and timbre consistent throughout, and are tagged with descriptions of these traits (professional, firm, casual, friendly, etc.), using standard methods from cognitive psychology. Additionally, in some embodiments, each phrase may include a matrix of metadata that quantifies the degree a particular phrase applies to each of the traits. The system will then map these traits to the correct set of descriptions of the phrase packages and enable the correct packages. This will allow customers or consultants to more easily get exactly the right Assistant personality (or conversation personality) for their company, particular target, and conversation. This may then be compared to the identity personality profile, and the phrases which are most similar to the personality may be preferentially chosen, in combination with the phrase performance metrics. A random element may additionally be incorporated in some circumstances to add phrase selection variability and/or continued phrase performance measurement accuracy. After phrase selection, the phrases replace the variables in the template. The completed templates are then output as a response (at 1750). The system may determine if additional actions are needed (at 1740), which may include attaching documents, setting calendar appointments, inclusion of web hooks, or similar activities.

Returning all the way back to FIG. 12, after the actions are generated, a determination is made whether there is an action conflict (at 1250). Manual review may be needed when such a conflict exists (at 1270). Otherwise, the actions may be executed by the system (at 1260).

Returning then to FIG. 10, after the response has been processed, a determination is made whether to deactivate the target (at 1075). Such a deactivation may be determined as needed when the target requests it. If so, then the target is deactivated (at 1090). If not, the process continues by determining if the conversation for the given target is complete (at 1080). The conversation may be completed when all objectives for the target have been met, or when there are no longer messages in the series that are applicable to the given target. Once the conversation is completed, the target may likewise be deactivated (at 1090).

However, if the conversation is not yet complete, the process may return to the delay period (at 1020) before preparing and sending out the next message in the series (at 1030). The process iterates in this manner until the target requests deactivation, or until all objectives are met. This concludes the main process for a comprehensive messaging conversation.

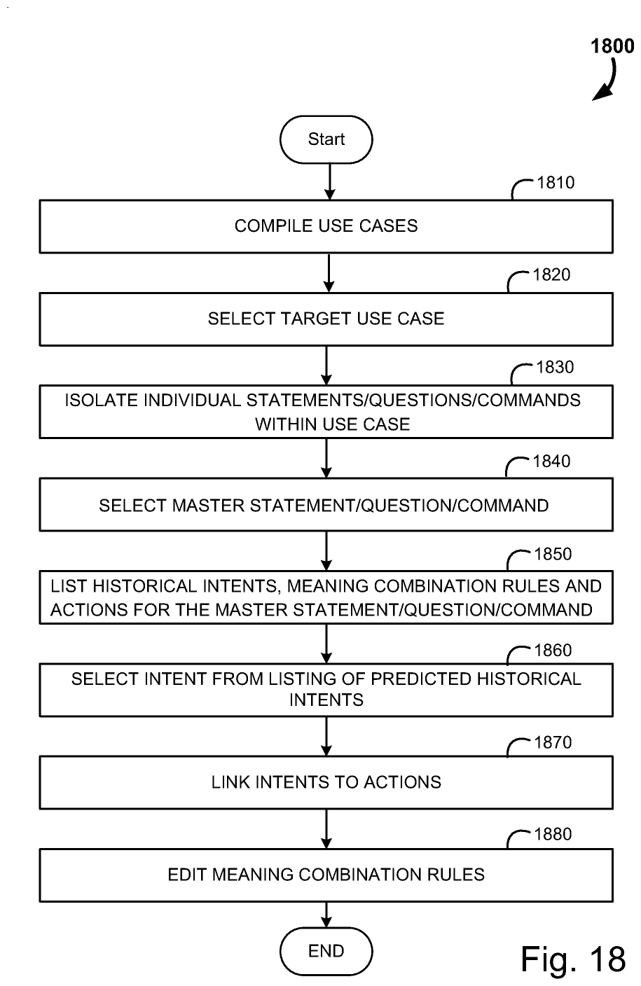

Turning now to FIG. 18, an example process flow diagram is provided for the operation of the recommendation engine, shown generally at 1800. In this example process, a listing of use cases is initially compiled (at 1810) based upon historical activity. A user then selects one of these use cases (at 1820), and the system isolates individual statements, questions and commands common to the historical use case (at 1830).

The user selects from these isolated statements, questions and commands a master statement, question or command (at 1840). The system provides historical intents, meanings combination rules, and actions that have been associated with the master statement, question or command (at 1850). This allows the user to select one or more intents that have been listed (at 1860) and link these to the actions presented (at 1870). The combination rules may additionally be edited (at 1880). These actions refine the model operation for the specific customer, allowing system personalization without sophisticated training requirements or hard coding of rules.

### III. System Embodiments

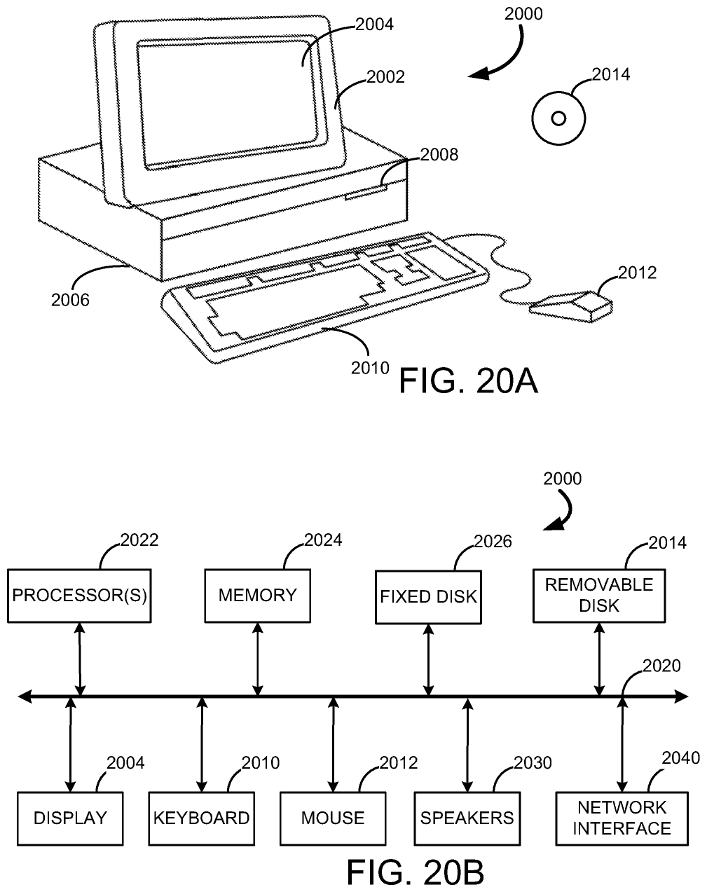

Now that the systems and methods for the conversation generation, dynamic messaging with variable replacements have been described, attention shall now be focused upon systems capable of executing the above functions. To facilitate this discussion, FIGS. 20A and 20B illustrate a Computer System 2000, which is suitable for implementing embodiments of the present invention. FIG. 20A shows one possible physical form of the Computer System 2000. Of course, the Computer System 2000 may have many physical forms ranging from a printed circuit board, an integrated circuit, and a small handheld device up to a huge super computer. Computer system 2000 may include a Monitor 2002, a Display 2004, a Housing 2006, a Storage Drive 2008, a Keyboard 2010, and a Mouse 2012. Storage 2014 is a computer-readable medium used to transfer data to and from Computer System 2000.

FIG. 20B is an example of a block diagram for Computer System 2000. Attached to System Bus 2020 are a wide variety of subsystems. Processor(s) 2022 (also referred to as central processing units, or CPUs) are coupled to storage devices, including Memory 2024. Memory 2024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Storage 2026 may also be coupled bi-directionally to the Processor 2022; it provides additional data storage capacity and may also include any of the computer-readable media described below. Fixed Storage 2026 may be used to store programs, data, and the like and is typically a secondary storage medium (such as a hard disk) that is slower than primary storage. It will be appreciated that the information retained within Fixed Storage 2026 may, in appropriate cases, be incorporated in standard fashion as virtual memory in Memory 2024. Removable Storage 2014 may take the form of any of the computer-readable media described below.

Processor 2022 is also coupled to a variety of input/output devices, such as Display 2004, Keyboard 2010, Mouse 2012 and Speakers 2030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2022 optionally may be coupled to another computer or telecommunications network using Network Interface 2040. With such a Network Interface 2040, it is contemplated that the Processor 2022 might receive information from the network or might output information to the network in the course of performing the above-described dynamic messaging processes. Furthermore, method embodiments of the present invention may execute solely upon Processor 2022 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2000 can be controlled by operating system software that includes a file management system, such as a storage operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for processing data of a message to map intents of a language to a meaning comprising:
parsing a message to generate individual sentences;
processing each sentence into n-grams, stems and tokens to generate a classification text for each sentence;
identifying a speech act in each of the classification text based upon utterances in the classification text;
selecting a subgroup of machine learned models from a plurality of machine learned models based upon the identified speech act; and
applying the subgroup of machine learned models to the classification text of each sentence generate a meaning for said sentence.

2. The method of claim 1, wherein the speech acts comprise questions, commands, desires, statements and commitments.

3. The method of claim 1, wherein the subgroup of machine learned models are additionally selected responsive to the conversation, a client, and an industry.

4. The method of claim 1, further comprising defining a feature set for the sentence responsive to the identified speech act.

5. The method of claim 4, further comprising generating a hierarchy of meanings responsive to the defined features.

6. The method of claim 5, wherein the meaning generated by applying the subgroup of machine learned models is in the hierarchy of meanings.

7. The method of claim 1, further comprising mapping the meaning to an action.

8. The method of claim 7, further comprising generating a response message incorporating the action.

9. The method of claim 8, wherein the response message includes selecting a template responsive to the action and populating variable fields in the template.

10. The method of claim 9, wherein the populating the variable fields is responsive to an entity extraction, historical variable success and a message personality.

11. A system for processing data of a message to map intents of a language to a meaning comprising:
a speech act engine for identifying a speech act in a classification text based upon utterances in the classification text, wherein the speech acts comprise questions, commands, desires, statements and commitments; and
a data processor for selecting a subgroup of machine learned models from a plurality of machine learned models based upon the identified speech act, wherein each speech act is associated with a subgroup of machine learned models that differ from one another, and applying the subgroup of machine learned models to the classification text of each sentence generate a meaning for said sentence.

12. The system of claim 11, wherein the classification text includes individual sentences of a response that have been normalized.

13. The system of claim 11, wherein the subgroup of machine learned models are additionally selected responsive to the conversation, a client, and an industry.

14. The system of claim 11, wherein the speech act engine further defines a feature set for the sentence responsive to the identified speech act.

15. The system of claim 14, wherein the speech act engine further generates a hierarchy of meanings responsive to the defined features.

16. The system of claim 15, wherein the meaning generated by applying the subgroup of machine learned models is in the hierarchy of meanings.

17. The system of claim 11, wherein the data processor further maps the meaning to an action.

18. The system of claim 17, further comprising a response engine for generating a response message incorporating the action.

19. The system of claim 18, wherein the response message includes selecting a template responsive to the action and populating variable fields in the template.

20. The system of claim 19, wherein the populating the variable fields is responsive to an entity extraction, historical variable success and a message personality.
